(19) United States
(12) Patent Application Publication
(10) Pub. No.: US 2026/0192853 A1
(43) Pub. Date: Jul. 9, 2026

(54) ELECTRONIC STEERING SYSTEM

(71) Applicant: HYUNDAI MOBIS CO., LTD., Seoul (KR)

(72) Inventors: Doo Young KIM, Yongin-si (KR); Seong Jun WOO, Yongin-si (KR); Young Sung KIM, Yongin-si (KR)

(73) Assignee: HYUNDAI MOBIS CO., LTD., Seoul (KR)

(21) Appl. No.: 19/365,293

(22) Filed: Oct. 22, 2025

(30) Foreign Application Priority Data
Jan. 8, 2025 (KR) 10-2025-0003121

(51) Int. Cl. B62D 6/00; B62D 5/00

(52) U.S. Cl. CPC B62D 6/008; B62D 5/006

(57) ABSTRACT

An electronic steering system is disclosed. The electronic steering system comprises a steering feedback actuator comprising a motor connected to a steering wheel and configured to generate reaction torque for steering feel, and an inverter configured to control the motor. The system includes a plurality of resistance units, each having one end connected between the motor and the inverter, and a plurality of switching units, each having one end connected to different another ends of the resistance units, and each having another end mutually short-circuited or connected to ground. The plurality of switching units become a closed state when there is an abnormality in power supply to the steering feedback actuator.

### CROSS-REFERENCE TO RELATED APPLICATIONS

This application claims priority from Korean Patent Application No. 10-2025-0003121 filed on Jan. 8, 2025 in the Korean Intellectual Property Office, the disclosure of which is incorporated herein by reference in its entirety.

### TECHNICAL FIELD

The present disclosure relates to an electronic steering system, and more particularly to technology for transmitting steering feel to a driver in a Steer-by-Wire System.

### BACKGROUND

An electronic steering system that removes mechanical connection between a steering wheel and vehicle wheels and transmits steering input through electronic signals is called a Steer-by-Wire system. The Steer-by-Wire system may be configured with a SFA (Steering Feedback Actuator) that provides steering feel to the driver and a RWA (Road Wheel Actuator) that is responsible for vehicle steering. Here, the SFA may perform a role of transmitting steering feel to the user by generating reaction torque in a direction opposite to the driver's steering force.

When an abnormality occurs in the RWA, it is obvious that a serious problem occurs where steering becomes impossible, and when an abnormality occurs in the SFA, it may also cause safety problems. For example, when power abnormality applied to the SFA occurs, or when reaction torque is not normally generated from the SFA due to reasons such as control signal abnormality that controls the SFA, problems may occur such as the driver feeling foreign sensation during driving, or deterioration of vehicle driving stability due to sharp steering.

The matters disclosed in this section as background technology are merely for enhancement of understanding of the background of the present disclosure and should not be taken as an acknowledgement or any form of suggestion that the matters form the related art already known to a person skilled in the art.

### SUMMARY

The present disclosure has been made in view of the above problems, and it is an object of the present disclosure to provide an electronic steering system capable of transmitting steering feel to a user even when an abnormality occurs in a power supply device or control signal.

In addition, it is an object to provide an electronic steering system capable of preventing driver over-steering due to loss of reaction torque.

Objects of the present disclosure are not limited to the objects mentioned above, and other objects not mentioned will be clearly understood by those skilled in the art from the description below.

To accomplish the above objects, an electronic steering system according to an embodiment of the present disclosure comprises: a steering feedback actuator comprising a motor connected to a steering wheel and configured to generate reaction torque for steering feel, and an inverter configured to control the motor; a plurality of resistance units, each having one end connected between the motor and the inverter; and a plurality of switching units, each having one end connected to different another ends of the resistance units, and each having another end mutually short-circuited or connected to ground, wherein the plurality of switching units become a closed state when there is an abnormality in power supply to the steering feedback actuator. According to an embodiment, the motor may generate the reaction torque based on back electromotive force (EMF) corresponding to steering velocity of the steering wheel when the plurality of switching units is in a closed state.

According to an embodiment, each resistance value of the plurality of resistance units may be set such that the reaction torque corresponding to the steering velocity maintains linearity when the plurality of switching units is in a closed state within a predetermined speed range of the steering velocity.

According to an embodiment, the system may further comprise a control unit configured to control the inverter, wherein the control unit may transmit a control command for maintaining the plurality of switching units in an open state to the plurality of switching units when normal control of the inverter is possible. According to an embodiment, the motor may comprise a plurality of inductance elements corresponding to each of a plurality of phases, and each of the plurality of resistance units may correspond to a different one of the plurality of phases.

According to an embodiment, each of the plurality of resistance units may be configured to have an impedance value that is above a predetermined ratio compared to impedance values of the plurality of inductance elements.

According to an embodiment, resistance values of each of the plurality of resistance units may be set based on a resistance value (R) of the following equation.

$${aR}^{2} + bR + c = 0 ,$$

$$a = \sqrt{3} \frac{180}{π} \frac{A \cdot eff}{{B}^{2}} ,$$

$$b = - Ke \cdot Kt ,$$

$$c = \sqrt{3} \frac{180}{π} \frac{A \cdot eff}{{B}^{2}} {( p ω L )}^{2} ,$$

(where A: a slope setting value of the reaction torque corresponding to the steering velocity when the plurality of switching units are in a closed state, B: gear ratio of the motor, eff: efficiency of the motor, Ke: back EMF constant, Kt: reaction torque constant, p: pole pairs, ω: angular velocity of the motor, L: inductance value of the inductance element, respectively mean)

According to an embodiment, the plurality of switching units may comprise normally closed-type (NC-type) switching elements that maintain a closed state when no external signal or external power is applied to the plurality of switching units.

According to an embodiment, the NC-type switching elements may comprise at least one of an NC-type relay and a depletion-mode MOSFET.

According to an embodiment, the system may further comprise a road wheel actuator configured to control steering of road wheels corresponding to a steering angle of the steering wheel.

As described above, the electronic steering system according to various embodiments of the present disclosure can provide an electronic steering system capable of transmitting steering feel to a user even when an abnormality occurs in a power supply device or control signal.

In addition, an electronic steering system capable of preventing driver over-steering due to loss of reaction torque can be provided.

Effects obtainable from the present disclosure are not limited to the effects mentioned above, and other effects not mentioned will be clearly understood by those skilled in the art from the description below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 shows an electronic steering system according to an embodiment of the present disclosure.

FIG. 2 is a view for explaining a steering feedback actuator according to an embodiment of the present disclosure.

FIG. 3 and FIG. 4 are views for explaining configuration of an emergency operation unit of a steering feedback actuator according to an embodiment of the present disclosure.

FIG. 5 and FIG. 6 are views for explaining reaction torque due to back EMF according to an embodiment of the present disclosure.

### DETAILED DESCRIPTION

Hereinafter, embodiments of the present disclosure will be described in detail with reference to the accompanying drawings, wherein the same or similar elements are designated by the same reference numerals regardless of the numerals in the drawings and redundant description thereof will be omitted. Specific structural or functional descriptions of embodiments of the present disclosure disclosed in this specification or application are illustrated only for the purpose of describing embodiments according to the present disclosure, and embodiments according to the present disclosure may be implemented in various forms and should not be construed as being limited to the embodiments described in this specification or application.

Since embodiments according to the present disclosure can be variously modified and can have various forms, specific embodiments will be illustrated in the drawings and described in detail in this specification or application. However, this is not intended to limit embodiments according to the concept of the present disclosure to specific disclosed forms, and should be understood to include all modifications, equivalents, and substitutes included in the spirit and technical scope of the present disclosure.

Unless defined otherwise, all terms used herein, including technical or scientific terms, have the same meaning as commonly understood by one of ordinary skill in the art to which this disclosure belongs. Terms such as those defined in commonly used dictionaries should be interpreted as having meanings consistent with those in the context of the related art, and should not be interpreted in an ideal or overly formal sense unless explicitly defined in this specification.

Hereinafter, embodiments disclosed in this specification will be described in detail with reference to the accompanying drawings, and the same or similar components will be assigned the same reference numerals regardless of drawing numerals, and redundant description thereof will be omitted.

In the description of the following embodiments, the term “predetermined” means that the numerical value of a parameter is determined in advance when the parameter is used in a process or algorithm. The numerical value of the parameter may be set when the process or algorithm starts according to embodiments, or may be set during a period in which the process or algorithm is performed.

The suffixes “module” and “unit” for components used in the following description are given or used in consideration of only the ease of specification writing, and do not have meanings or roles that are distinguished from each other by themselves.

In describing the embodiments disclosed in this specification, when it is determined that detailed descriptions of related known technologies may obscure the gist of the embodiments disclosed in this specification, the detailed descriptions thereof are omitted. In addition, the accompanying drawings are only for easy understanding of the embodiments disclosed in this specification, and the technical ideas disclosed in this specification are not limited by the accompanying drawings, and should be understood to include all modifications, equivalents, and substitutes included in the spirit and technical scope of the present disclosure.

Terms including ordinal numbers such as first and second may be used to describe various components, but the components are not limited by the terms. The terms are used only for the purpose of distinguishing one component from another component.

When a component is referred to as being “connected” or “accessed” to another component, it should be understood that it may be directly connected or accessed to the other component, but other components may exist in between. On the other hand, when a component is referred to as being “directly connected” or “directly accessed” to another component, it should be understood that no other components exist in between.

Singular expressions include plural expressions unless the context clearly indicates otherwise.

In this specification, terms such as “comprises” or “has” are intended to specify that features, numbers, steps, operations, components, parts, or combinations thereof described in the specification exist, and should be understood as not excluding in advance the existence or addition possibility of one or more other features, numbers, steps, operations, components, parts, or combinations thereof.

In addition, unit or control unit included in names such as Motor Control Unit (MCU) is merely a term widely used in naming control devices (Controllers) that control specific functions of vehicles, and does not mean a generic function unit.

Hereinafter, the electronic steering system will be described assuming a case where it is designed as a Steer-by-Wire system that removes mechanical connection between the steering wheel and vehicle wheels and transmits steering input through electronic signals.

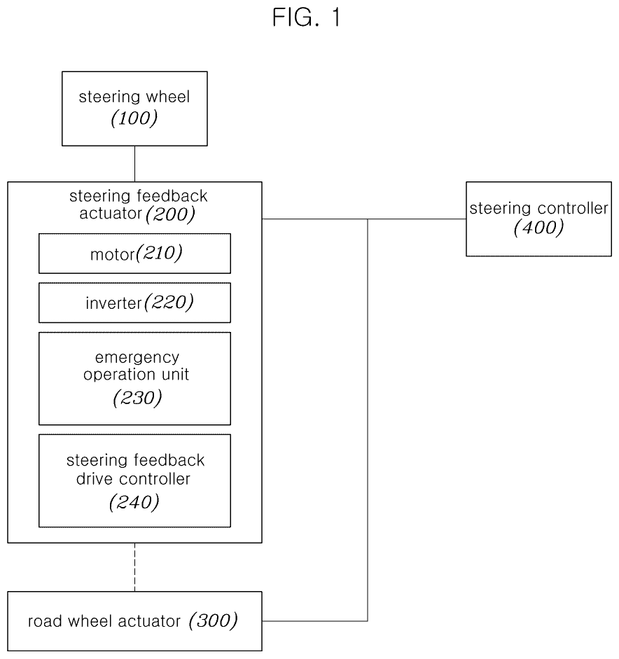

Referring to FIG. 1, the electronic steering system may comprise a steering wheel 100, a steering feedback actuator 200, a road wheel actuator 300, and a steering controller 400.

The steering wheel 100 is a device for a driver to control steering of a vehicle, and the driver may control a steering angle of road wheels through the steering wheel 100.

The steering feedback actuator (200, SFA: Steering Force Actuator) comprises a motor 210, an inverter 220, an emergency operation unit 230, and a motor drive controller 240, and is connected to the steering wheel 100 to apply reaction torque for providing steering feel similar to actual road conditions to a user. That is, the steering feedback actuator 200 may provide help for a driver to intuitively recognize a steering state of a vehicle and perform stable steering by applying reaction torque to the steering wheel 100.

The road wheel actuator (RWA: Road Wheel Actuator, 300) may control a steering angle of road wheels (not shown) corresponding to a steering angle of the steering wheel 100. For example, the road wheel actuator 300 may receive a steering angle signal according to user manipulation from the steering controller 400, and control a motor (not shown) based on the received steering angle signal to adjust a rotation angle of road wheels (not shown).

The steering controller 400 may monitor a steering state of the steering wheel 100 and a steering state of a vehicle, and perform steering control of the vehicle by controlling the steering feedback actuator 200 and the road wheel actuator 300.

When power and control signals supplied to the steering feedback actuator 200 are normal (hereinafter, normal state), the steering feedback actuator 200 may generate reaction torque based on power supplied from a battery (not shown) and control commands received from the steering controller 400 and apply the reaction torque to the steering wheel 100.

Meanwhile, when an abnormality occurs in power or control signals supplied to the steering feedback actuator 200, the steering feedback actuator 200 may not be able to generate reaction torque based on power supplied from a battery (not shown) and control commands received from the steering controller 400 (hereinafter, abnormal state).

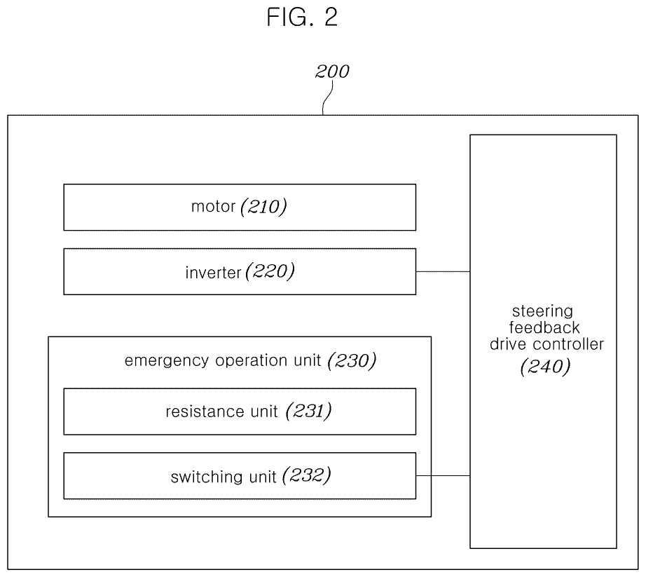

Hereinafter, the steering feedback actuator 200 capable of generating appropriate reaction torque based on back electromotive force (EMF) even in such an abnormal state will be described with reference to FIG. 2 to FIG. 4.

Referring to FIG. 2, the steering feedback actuator 200 may comprise a motor 210, an inverter 220, an emergency operation unit 230, and a steering feedback drive controller 240.

The motor 210 is connected to the steering wheel 100 and may generate reaction torque applied to the steering wheel 100. For example, in a normal state, the motor 210 may generate reaction torque applied to the steering wheel 100 based on power applied from the inverter 220. As another example, in an abnormal state, through operation of an emergency operation unit 230 to be described later, the motor 210 may generate reaction torque applied to the steering wheel 100 based on back EMF corresponding to steering velocity of the steering wheel 100.

The inverter 220 comprises a plurality of switching elements, and is connected to the motor 210 to supply power for the motor 210 to generate reaction torque in a normal state.

The emergency operation unit 230 may provide a closed loop to each phase winding of the motor 210 in an abnormal state, thereby enabling reaction torque due to back EMF to be generated in the motor 210 when the steering wheel 100 rotates. For this purpose, the emergency operation unit 230 may comprise a resistance unit 231 and a switching unit 232 connected in series.

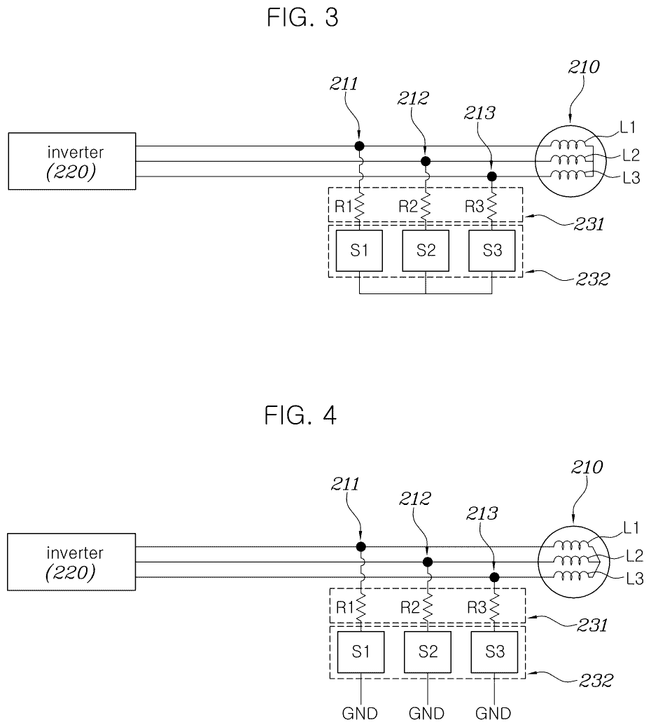

The resistance unit 231 may comprise a plurality of resistance elements. At this time, resistance values of the plurality of resistance elements may be set such that reaction torque of the motor 210 corresponding to steering velocity of the steering wheel 100 maintains linearity when the switching unit 232 is in a closed state. Here, setting of resistance values of resistance elements included in the resistance unit 231 will be described in detail later with reference to FIG. 3 and FIG. 4.

The switching unit 232 may comprise a plurality of switching elements. At this time, the switching unit 232 may be configured with a plurality of NC-type switching elements that maintain a closed state when no external signal or external power is applied to the switching unit 232. For example, the NC-type switching elements may comprise at least one of a NC-type relay and a depletion-mode MOSFET.

The motor drive controller 240 may control the inverter 220 such that the motor 210 generates reaction torque in a normal state, and may control the switching unit 232 to maintain an open state in a normal state. For example, in a normal state, the motor drive controller 240 may transmit a switching control command for maintaining the switching unit 232 in an open state to the switching unit 232.

Referring to FIG. 3, the steering feedback actuator 200 comprises a motor 210 including a first inductor element L1 and a first node 211 corresponding to U phase, a second inductor element L2 and a second node 212 corresponding to V phase, a third inductor element L3 and a third node 213 corresponding to W phase, an inverter 220 connected to the motor 210, a resistance unit 231 including a first resistance element R1 having one end connected to the first node 211, a second resistance element R2 having one end connected to the second node 212, and a third resistance element R3 having one end connected to the third node, and a switching unit 232 including a first switching element S1 having one end connected to another end of the first resistance element R1, a second switching element S2 having one end connected to another end of the second resistance element R2, and a third switching element S3 having one end connected to another end of the third resistance element R3.

Here, the other ends of the first to third switching elements S1, S2, and S3 included in the switching unit 232 may be configured to be mutually short-circuited.

However, the order in which the resistance unit 231 and the switching unit 232 of the emergency operation unit 230 are connected is exemplary, and for example, one ends of the first to third switching elements S1, S2, and S3 may be connected to the first to third nodes 211, 212, and 213 respectively, and one ends of the first to third resistance elements R1, R2, and R3 may be connected to another ends of the first to third switching elements S1, S2, and S3 respectively, such that another ends of the first to third resistance elements R1, R2, and R3 are mutually short-circuited.

That is, the first to third resistance elements R1, R2, and R3 included in the resistance unit 231 and the first to third switching elements S1, S2, and S3 included in the switching unit 232 may be connected in series respectively to configure a plurality of series circuits corresponding to U, V, W phases of the motor 210 respectively, and in this case, one ends of the plurality of series circuits may be connected to the first to third nodes 211, 212, and 213 respectively, and another ends of the plurality of series circuits may be configured to be mutually short-circuited.

Referring to FIG. 4, the steering feedback actuator 200 comprises a motor 210 including a first inductor element L1 and a first node 211 corresponding to U phase, a second inductor element L2 and a second node 212 corresponding to V phase, a third inductor element L3 and a third node 213 corresponding to W phase, an inverter 220 connected to the motor 210, a resistance unit 231 including a first resistance element R1 having one end connected to the first node 211, a second resistance element R2 having one end connected to the second node 212, and a third resistance element R3 having one end connected to the third node, and a switching unit 232 including a first switching element S1 having one end connected to another end of the first resistance element R1, a second switching element S2 having one end connected to another end of the second resistance element R2, and a third switching element S3 having one end connected to another end of the third resistance element R3.

Here, the other ends of the first to third switching elements S1, S2, and S3 included in the switching unit 232 may be configured to be electrically connected to a ground terminal GND.

In this case, current generated due to back EMF is output to the ground terminal, thereby reducing heat generation problems due to overcurrent applied to the steering feedback actuator 200.

Referring to FIG. 3 and FIG. 4 together, when the steering feedback actuator 200 is in a normal state, the first to third switching elements S1, S2, and S3 included in the switching unit 232 may maintain an open state.

For example, when the motor drive controller 240 determines that control signals transmitted to the inverter 220 and the switching unit 232 and power applied to the motor 210 are normal, the motor drive controller 240 may control the first to third switching elements S1, S2, and S3 included in the switching unit 232 to maintain an open state.

In this case, the motor 210 may generate reaction torque based on power received from the inverter 220.

Meanwhile, when the steering feedback actuator 200 is in an abnormal state, the first to third switching elements S1, S2, and S3 included in the switching unit 232 may maintain a closed state.

In this case, the motor 210 may generate reaction torque based on back EMF corresponding to steering velocity of the steering wheel 100.

For example, when an abnormality occurs in at least one of power applied to the steering feedback actuator 200 and control signals that the motor drive controller 240 transmits to the inverter 220 and the switching unit 232, and reaction torque generation of the motor 210 by controlling the inverter 220 becomes impossible, signals applied to the switching unit 232 are cut off and the first to third switching elements S1, S2, and S3 may be switched to a closed state.

When a rotor of the motor 210 rotates in a state where no external power is applied to the motor 210, induced voltage and back EMF due to electromagnetic induction phenomenon may be generated in the first to third inductance elements L1, L2, and L3 which are stator windings of the motor 210.

Here, resistance values of the first to third resistance elements R1, R2, and R3 may be set such that reaction torque corresponding to steering velocity maintains linearity within a predetermined steering velocity range of the steering wheel 100 when the first to third switching elements S1, S2, and S3 are in a closed state.

Specifically, back EMF generated in the motor 210 can be represented as shown in Equation 1 and Equation 2 below. Here, E is back EMF, R is resistance value of resistance elements, p is pole pairs, ω is motor angular velocity, I is motor current, and Ke is back EMF constant obtained by dividing line-to-line back EMF peak value by motor rotational angular velocity, may respectively mean.

$$\vec{E} = ( R + jp ω L ) \cdot \vec{I} \qquad Equation 1$$

$$\vert \vec{E} \vert = Ke \cdot \frac{ω}{\sqrt{3}} \qquad Equation 2$$

Referring to Equation 1 and Equation 2, the steering feedback actuator 200 may be configured such that impedance values of the first to third resistance elements R1, R2, and R3 have much larger values than impedance values of the inductance elements L1, L2, and L3 so that reaction torque corresponding to angular velocity of the motor 210 changes linearly.

That is, impedance values of the first to third resistance elements R1, R2, and R3 may be set to have impedance values above a predetermined ratio (for example, 10 times or more) compared to impedance values of the first to third inductance elements L1, L2, and L3.

Meanwhile, resistance values of the first to third resistance elements R1, R2, and R3 may be set to satisfy fail-safe requirements of a vehicle.

In this case, resistance values of the first to third resistance elements R1, R2, and R3 may be set based on resistance value R derived based on Equation 3 to Equation 6 below. Here, A: slope setting value of reaction torque corresponding to steering velocity when the switching unit 232 is in a closed state, B: gear ratio of the motor 210, eff: efficiency of the motor 210, Ke: back EMF constant, Kt: reaction torque constant, p: pole pairs, ω: angular velocity of the motor 210, L: inductance value of inductance elements, may respectively mean.

$$\frac{Δ T}{\frac{180}{π} Δω} = A / {B}^{2} \qquad Equation 3$$

$$Kt \cdot \vert \vec{I} \vert cos β = A \cdot eff / {B}^{2} \qquad Equation 4$$

$${aR}^{2} + bR + c = 0 \qquad Equation 5$$

$$a = \sqrt{3} \frac{180}{π} \frac{A \cdot eff}{{B}^{2}}$$

$$b = - Ke \cdot Kt$$

$$c = √ 3 \; 180 / π ( A \cdot eff ) / {B}^{⋀} 2 {( p ω L )}^{⋀} 2$$

$$R = \frac{- b + \sqrt{{b}^{2} - 4 ac}}{2 a} \qquad Equation 6$$

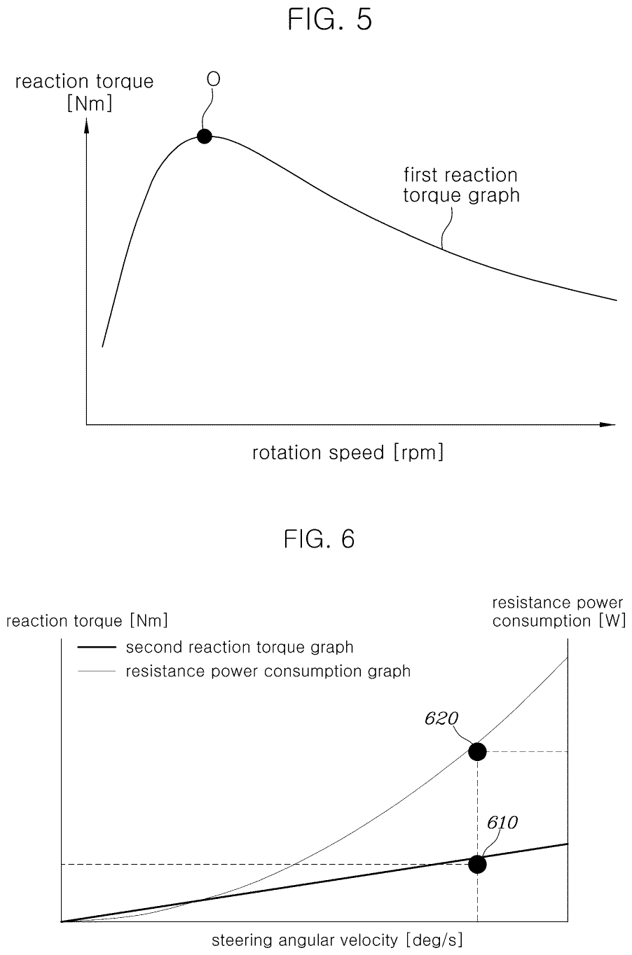

Referring to FIG. 5, a first reaction torque graph due to back EMF generated according to rotation speed of the motor 210 is shown.

Referring to the first reaction torque graph, reaction torque due to back EMF has characteristics that reaction torque of the motor 210 corresponding to rotation speed of the motor 210 increases linearly up to an inflection point O, but may have nonlinear characteristics after passing the inflection point O.

At this time, reaction torque due to back EMF decreases nonlinearly around the inflection point O, and a user may feel foreign sensation when steering the steering wheel 100 around the inflection point O.

Therefore, resistance values of the first to third resistance elements R1, R2, and R3 may be set such that reaction torque corresponding to steering velocity maintains linearity within a predetermined steering velocity range. Here, the predetermined steering velocity range is a design specification that must be determined in advance to select resistance values during design, and it is preferable to be set widely within a range that provides wider coverage from a fail-safe perspective, but a section where torque is low in a low RPM band is not excessively long.

For example, the steering velocity range may be set considering maximum steering velocity under normal driving situations of general drivers (for example, excluding cases such as sports driving or emergency steering), but this is exemplary and is not necessarily limited thereto.

Referring to FIG. 6, when a slope of reaction torque corresponding to predetermined steering angular velocity of the motor 210 has a predetermined slope setting value A (for example, 0.03 Nm/(deg/s)), a second reaction torque graph representing reaction torque corresponding to steering angular velocity and a resistance power consumption graph representing resistance element power consumption corresponding to steering angular velocity are shown respectively.

Referring to the second reaction torque graph, a first point 610 representing steering angular velocity corresponding to predetermined steering reaction torque is shown.

In addition, referring to the resistance element power consumption graph, under the same steering angular velocity condition as the steering angular velocity of the first point 610, a second point 620 representing power consumption of resistance elements is shown.

In this case, the first to third resistance elements R1, R2, and R3 included in the resistance unit 231 may be designed to withstand heat generation occurring under conditions of continuous operation with predetermined steering reaction torque.

That is, the first to third resistance elements R1, R2, and R3 may be designed as resistance elements with specifications capable of withstanding heat generation corresponding to power consumption of the second point 620 under conditions of continuous operation with predetermined steering reaction torque of the first point 610.

In conventional Steer-by-Wire (SbW) systems, when an abnormality occurs in power supplied to SFA (Steering Feel Actuator) or a controller that controls it, a problem may occur where it is difficult to provide appropriate steering feel to a steering wheel.

In addition, even if a redundancy structure including an auxiliary steering unit is included in preparation for an abnormal state, when the auxiliary steering unit is configured to mechanically connect a steering wheel and road wheels, advantages of the Steer-by-Wire system such as vehicle weight reduction and design flexibility may be reduced by half.

Meanwhile, even if the auxiliary steering unit is configured to electrically connect a steering wheel and road wheels, when power applied to the auxiliary steering unit is cut off, the same problem may occur where it is difficult to provide steering feel through SFA.

The proposed Steer-by-Wire system of the present disclosure can provide steering feel to a steering wheel based on back EMF generated in SFA even when an abnormality occurs in power supply or controller.

In this case, even when power cutoff or control signal abnormality occurs, stable steering feel can be transmitted to a driver to prevent over-steering.

In addition, the proposed Steer-by-Wire system of the present disclosure can provide a principle for selecting specifications of resistance elements capable of maintaining linearity of reaction torque according to steering velocity of a steering wheel within a target range even in an abnormal state.

Furthermore, the proposed disclosure can provide additional advantages such as cost reduction, structural simplification, and securing space in a vehicle compared to conventional redundant configurations.

Meanwhile, the present disclosure described above can be implemented as computer-readable code on a medium on which a program is recorded. Computer-readable media include all types of recording devices that store data that can be read by computer systems. Examples of computer-readable media include HDD (Hard Disk Drive), SSD (Solid State Disk), SDD (Silicon Disk Drive), ROM, RAM, CD-ROM, magnetic tape, floppy disk, optical data storage device, etc. Therefore, the detailed description above should not be construed as restrictive in all respects but should be considered as illustrative.

The scope of the present disclosure should be determined by reasonable interpretation of the appended claims, and all changes within the equivalent scope of the present disclosure are included in the scope of the present disclosure.

What is claimed is:

1. An electronic steering system comprising:
a steering feedback actuator comprising a motor connected to a steering wheel and configured to generate reaction torque for steering feel, and an inverter configured to control the motor;
a plurality of resistance units, each having a first end and second end, wherein the first end of each resistance unit is connected between the motor and the inverter; and
a plurality of switching units, each having a first end and second end, wherein the first end of each switching unit is connected to the second end of a different one of the plurality of resistance units, and a plurality of second ends of the plurality of switching units is electrically connected to each other or to ground,
wherein the plurality of switching units is configured to be in a closed state in response to an abnormality occurring in power supply to the steering feedback actuator.

2. The electronic steering system according to claim 1, wherein the motor is configured to generate the reaction torque based on back electromotive force (back EMF) corresponding to steering velocity of the steering wheel in a state in which the plurality of switching units is closed.

3. The electronic steering system according to claim 2, wherein a resistance value of each of the plurality of resistance units is set such that the reaction torque corresponding to the steering velocity maintains linearity, when the plurality of switching units is in a closed state within a predetermined speed range of the steering velocity.

4. The electronic steering system according to claim 1, further comprising a control unit configured to control the inverter, wherein the control unit is further configured to transmit a control command to the plurality of switching units to maintain the plurality of switching units in an open state when the inverter is capable of normal control.

5. The electronic steering system according to claim 3, wherein:
the motor comprises a plurality of inductance elements respectively corresponding to a plurality of phases, and
each of the plurality of resistance units corresponds to a different one of the plurality of phases.

6. The electronic steering system according to claim 5, wherein the plurality of resistance units is configured such that an impedance value of each of the plurality of resistance units is set to be above a predetermined ratio compared to a plurality of impedance values of the plurality of inductance elements.

7. The electronic steering system according to claim 5, wherein a plurality of resistance values of the plurality of resistance units is set based on a resistance value (R) satisfying:
$${aR}^{2} + bR + c = 0 ,$$
$$a = \sqrt{3} \frac{180}{π} \frac{A \cdot eff}{{B}^{2}} ,$$
$$b = - Ke \cdot Kt , and$$
$$c = \sqrt{3} \frac{180}{π} \frac{A \cdot eff}{{B}^{2}} {( p ω L )}^{2} ,$$
where A is a slope setting value of the reaction torque corresponding to the steering velocity in a case where the plurality of switching units is in a closed state, B is a gear ratio of the motor, eff is efficiency of the motor, Ke is a back EMF constant, Kt is a reaction torque constant, p is pole pairs, ω is angular velocity of the motor, and L is an inductance value of the plurality of inductance elements.

8. The electronic steering system according to claim 1, wherein the plurality of switching units comprises a plurality of normally closed-type (NC-type) switching elements configured to maintain a closed state when no external signal or external power is applied to the plurality of switching units.

9. The electronic steering system according to claim 8, wherein the plurality of NC-type switching elements comprises an NC-type relay or a depletion-mode MOSFET.

10. The electronic steering system according to claim 1, further comprising a road wheel actuator configured to control steering of a plurality of road wheels according to a steering angle of the steering wheel.
